(19) United States
(12) Patent Application Publication
(10) Pub. No.: US 2010/0173706 A1
(43) Pub. Date: Jul. 8, 2010

(54) IMAGE DISPLAY CONTROL DEVICE, GAME APPARATUS, AND PROGRAM AND RECORDING MEDIUM HAVING THE SAME

(75) Inventors: Yuichi Nakahara, Kanagawa (JP); Kotaro Matsumura, Kanagawa (JP); Daisuke Sato, Kanagawa (JP); Yoshitaka Tamura, Kanagawa (JP); Shinya Ito, Kanagawa (JP)

Correspondence Address: Ditthavong Mori & Steiner, P.C., 918 Prince Street, Alexandria, VA, 22314, US

(73) Assignee: Konami Digital Entertainment Co., Ltd., Tokyo (JP)

(21) Appl. No.: 12/663,024

(22) PCT Filed: Jun. 2, 2008
(86) PCT No.: PCT/JP2008/060145

§ 371 Date: Dec. 4, 2009

(30) Foreign Application Priority Data
Jun. 5, 2007 (JP) 2007-148808

(51) Int. Cl. A63F 13/00; A63F 9/24

(52) U.S. Cl. 463/32; 463/43

(57) ABSTRACT

The present invention provides an image display control device, etc., capable of preventing a specific object, which is required not to be seen by the user when the specific object is positioned outside a visible field, among various objects located in a virtual field from being seen by the user in an easy method when the specific object is positioned outside the visible field.

An image display control device comprises: an image information storage unit for storing image information necessary for displaying, at a display unit, an image of various objects located in a virtual field constituted of a two-dimensional virtual plane or a three-dimensional virtual space; a location decision unit for deciding location of various objects in the virtual field; and a display control unit for executing display control to display, at the display unit, the image of the object located in a visible field, which is a part of the virtual field, in a state where the visible field is viewed from a predetermined viewpoint direction, based on location of the objects decided by the location decision unit and image information stored in the image information storage unit, a transparentizing process for transparentizing an image of a specific object located in the virtual field by the location decision unit when the specific object is positioned at least in an adjacent field adjacent to the visible field on the outside of the visible field, and an opacifying process for opacifying an image of the specific object when the specific object is positioned inside the visible field.

### TECHNICAL FIELD

The present invention relates to an image display control device for displaying, at a display unit, an image of an object which is located in a visible field that is a part of a virtual field constituted of a two-dimensional virtual plane or a three-dimensional virtual space, in a state where the visible field is viewed from a predetermined viewpoint; a game apparatus; and a program and a recording medium having the program.

### BACKGROUND ART

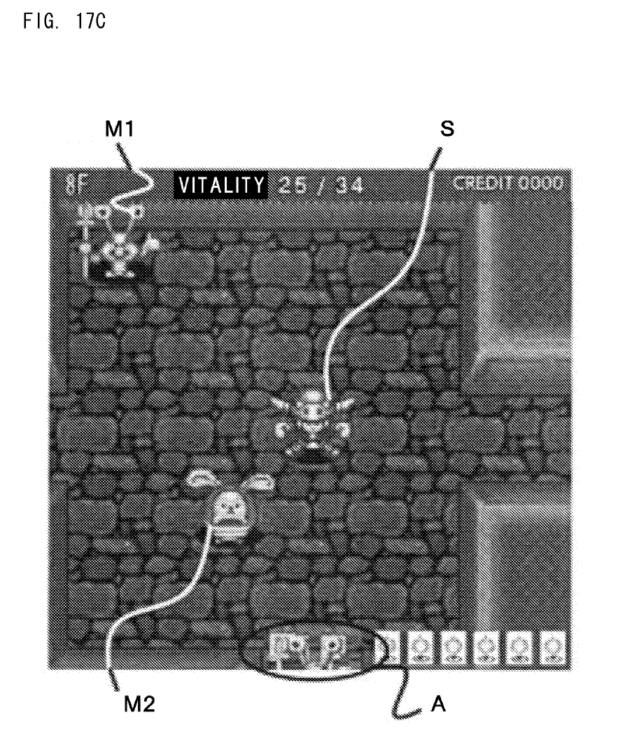

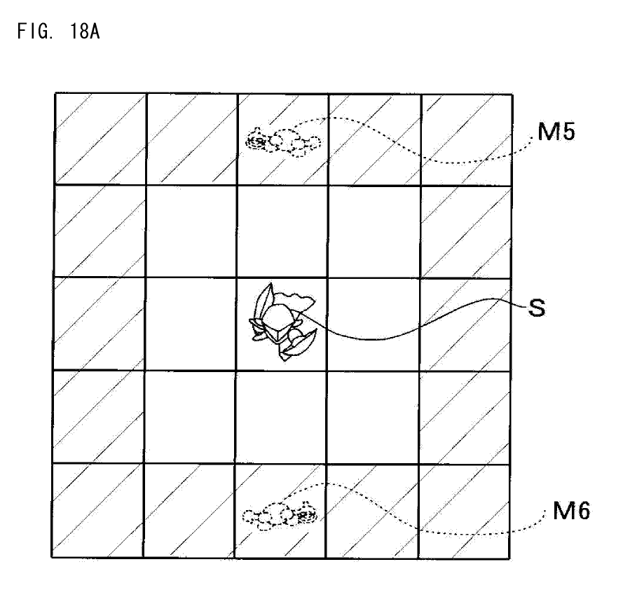

Conventionally, there is an image display control device to be provided in a display device of a game apparatus, etc. having a display unit, the image display control device displaying, at the display unit, an image of various objects which are located in a visible field that is a part of a virtual field in a state where the visible field is viewed from a predetermined viewpoint. For example, disclosed in Patent Document 1 is a game apparatus for executing a game in which the player aims to operate a central character S (two-dimensional object), which is an operational object, to pick up jewels that appear in a dungeon (virtual field) constituted of a two-dimensional virtual plane and to escape from the dungeon. FIG. 17A illustrates an example of a game screen of the game apparatus. In the dungeon, various kinds of objects, such as backgrounds constituting floors and walls of the dungeon, enemy monsters M1, M2, M3 which prevent ahead of the central character S and items such as magic cards, are located as well as the central character S. Moreover, the image of various objects in a state where a part (visible field) of the dungeon is viewed from a predetermined viewpoint is displayed as a game screen as illustrated in FIG. 17A. In addition, the visible field in FIG. 17A is the entire game screen. When the central character S moves in the dungeon by operating the central character S by the player, a viewpoint position is moved in a manner that the central character S is always positioned at the center of the screen. Accordingly, by moving the central character S in the dungeon, the player can cause a variety of areas in the dungeon to be displayed on the game screen. The above game apparatus adopts a turn system, although it is not explained in detail in the Patent Document 1. More specifically, one turn proceeds when the central character S takes one action such as movement by a single division, a single attack or a single use of a magic card. In addition, the enemy monsters M1, M2, M3 also take one action such as movement by a single division or a single attack by one turn, such a case of the central character S. In such a turn system, the player decides the action of the central character S at the next turn from a comprehensive standpoint on the situation around the central characters S, such as the location of the passages or walls of the dungeon around the central character S or the number, the positions and the strength of the enemy monsters M1, M2, M3 positioned around the central character S. Accordingly, the player can grasp the situation around the central character S in a wider area and can play the game more advantageously when an area (visible field in a dungeon) where the player can see all at once in the game screen is wider. On the contrary, when a mask image is superimposed on the game screen (9 divisions in horizontal direction times 7 divisions in vertical direction) of FIG. 17A as illustrated in FIG. 17B and thereby a visible field is narrowed down (5 divisions in horizontal direction times 5 divisions in vertical direction), an area where the player can grasp the situation around the central character S is narrowed down and the level of difficulty of the game can be raised.

Patent Document 1: Japanese Published Unexamined Patent Application No. 2002-119765

### DISCLOSURE OF THE INVENTION

### Problems to be Solved by the Invention

However, as illustrated in FIG. 17B, a part of the enemy monster M3 such as the part denoted by the symbol A in the figure may possibly come into the visible field and be seen by the player when the enemy monster is positioned in an adjacent division adjacent to the visible field on the outside of the visible field, depending on the shape or the size of the image of the enemy monster. Therefore, there was a problem that the effort to prevent the player from grasping the situation on the outside of the visible field by limiting the visible field in a manner, such as superimposing the mask image, ends in failure. The problem may arise not only in a case where the visible field is narrowed down by superimposing the mask image but also in a case where the visible field of FIG. 17B is displayed over the entire displayed area of the game screen as illustrated in FIG. 17C. In addition, each image of all enemy monsters can always be kept inside one division in order to prevent the entire part of the enemy monster positioned in the division adjacent to the visible field on the outside of the visible field from coming into the visible field, although the degree of freedom of expression of enemy monsters is reduced in such a case.

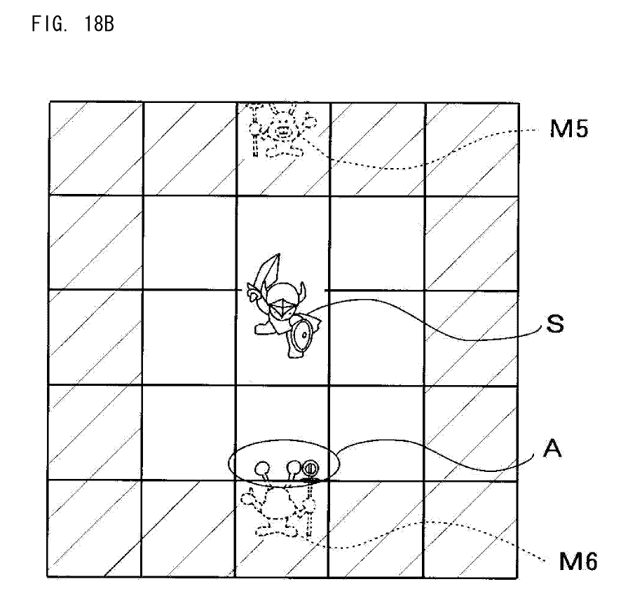

The above problem, which has been explained using the case of a virtual field constituted of a two-dimensional virtual plane, will become a more serious problem in the case of a virtual field constituted of a three-dimensional virtual space. The following description will explain the problem referring to FIG. 18A and FIG. 18B.

FIG. 18A and FIG. 18B are explanatory views for schematically illustrating an example of a game screen in a case where the dungeon described above expresses in a three-dimensional virtual space and each object expresses in a three-dimensional object. In addition, FIG. 18A is a game screen in a case where the viewpoint direction is parallel to a normal direction of a dungeon floor, and FIG. 18B is a game screen in a case where the viewpoint direction is inclined to the normal direction of the dungeon floor.

In FIG. 18A and FIG. 18B, a visible field is constituted of nine divisions including one division where the central character S is positioned and eight divisions surrounding the central character S, and the parts marked with diagonal lines in the figures are divisions positioned outside the visible field. In addition, a part of an enemy character located outside the visible field, which is superimposed over the area marked with diagonal lines, is described with dotted lines in FIG. 18A and FIG. 18B for convenience of explanation, although the part is not displayed on the game screen.

When the viewpoint direction is parallel to the normal direction of the dungeon floor as in FIG. 18A, a part of each enemy monster M5, M6 positioned outside the visible field is prevented from coming into the visible field as long as each image of all enemy monsters is always kept inside one division, although the degree of freedom of expression of enemy monsters is reduced as described above. Consequently, the player cannot see the enemy monsters M5, M6 existing outside the visible field, and the effort to prevent the player from grasping the situation on the outside of the visible field by limiting the visible field does not end in failure. However, when the viewpoint direction is inclined to the normal direction of the dungeon floor as illustrated in FIG. 18B, a part of the enemy monster M6 such as a part denoted by the symbol A may possibly come into the visible field and be seen by the player, even if each image of all enemy monsters is always kept inside one division as described above. Here, one of the advantages of the virtual field constituted of not the two-dimensional plane but the three-dimensional space is that various objects in the visible field can be described from a variety of directions by changing the viewpoint direction. Consequently, the above problem, which can be resolved in the case of the virtual field constituted of the two-dimensional plane by always keeping each image of all enemy monsters inside one division, cannot be resolved in the case of the virtual field constituted of the three-dimensional space.

In addition, the problem described above is not limited to a game apparatus but may possibly arise similarly when an image of an object located in a visible field, which is a part of a virtual field constituted of the two-dimensional virtual plane or the three-dimensional virtual space, in a state where the visible field is viewed from a predetermined viewpoint direction is displayed at a display unit and it is required to prevent a specific object from being seen by the user when the specific object is positioned outside the visible field.

The present invention realizes and provides an image display control device capable of preventing a specific object, which is required not to be seen by the user when the specific object is positioned outside a visible field, among various objects located in a virtual field from being seen by the user in an easy method when the specific object is positioned outside the visible field; a game apparatus; and a program and a recording medium having the program.

### Means for Solving the Problem

As an aspect of the present invention, it is listed that an image display control device includes: an image information storage unit for storing image information necessary for displaying, at a display unit, an image of various objects located in a virtual field constituted of a two-dimensional virtual plane or a three-dimensional virtual space; a location decision unit for deciding location of various objects in the virtual field; and a display control unit for executing display control to display, at the display unit, the image of the object located in a visible field, which is a part of the virtual field, in a state where the visible field is viewed from a predetermined viewpoint direction, based on location of the objects decided by the location decision unit and image information stored in the image information storage unit, a transparentizing process for transparentizing an image of a specific object located in the virtual field by the location decision unit when the specific object is positioned at least in an adjacent field adjacent to the visible field on the outside of the visible field, and an opacifying process for opacifying an image of the specific object when the specific object is positioned inside the visible field.

In the present image display control device, when the specific object located in the virtual field is positioned at least in the adjacent field adjacent to the visible field on the outside of the visible field, the image of this specific object is transparent. That is, the specific object itself positioned in the adjacent field is not deleted from the virtual field but the image of this specific object is not displayed at the display unit while being located in the virtual field. Consequently, it is possible to reliably prevent the image of the specific object positioned outside the visible field from being seen by the user without complicating a decision process regarding the location of the specific object in the virtual field.

In addition, in the above image display control device, the virtual field may be constituted of a three-dimensional virtual space, at least the specific object among the various objects may be a three-dimensional object, and the display control unit may change a viewpoint direction according to a predetermined viewpoint direction changing condition.

Here, the meaning of “changing the viewpoint direction” includes not only changing a viewpoint direction from one viewpoint but also switching one viewpoint in use among a plurality of viewpoints to another viewpoint.

In the present image display control device, the image of the three-dimensional object located in the visible field viewed from a plurality of viewpoint directions can be displayed at the display unit. Regarding the virtual field constituted of the three-dimensional virtual space in which the viewpoint direction can be changed as described above, resolution of the problem described above is more difficult than in the case of a virtual field constituted of a two-dimensional virtual plane. That is, in the case of the virtual field constituted of the two-dimensional virtual plane, it is possible to cope with the problem described above by devising the shape or the size of the image of the specific object as described above, although the degree of freedom of expression of the specific object is reduced. However, in the case of the virtual field constituted of the three-dimensional virtual space in which the viewpoint direction can be changed, it is impossible to resolve the problem described above by such handling. With the present image display control device, it is possible to resolve the problem described above in the virtual field constituted of the three-dimensional virtual space in which the viewpoint direction can be changed, in an easy method. Accordingly, it is possible to resolve said problem in the case of the virtual field constituted of the three-dimensional virtual space, for which resolution of the problem described above becomes more difficult than the case of the virtual field constituted of the two-dimensional virtual plane.

In addition, in the above image display control device, the display control unit may execute display control to display, at the display unit, the image of the object located in the visible field together with an image of another object excluding the specific object located in the adjacent field, and a field differentiation processing unit for executing image processing for visually differentiating the visible field and the adjacent field may be provided.

Moreover, in the above image display control device, the image processing to be executed by the field differentiation processing unit may be a process for generating an image obtained by superimposing a semi-transparent mask image on the image of the object located in the adjacent field.

In these image display control devices, not only the images of objects located in the visible field but also the images of objects (excluding the specific object) located in the adjacent field is displayed. Accordingly, it is possible to expand a displayed area of the virtual field to be displayed at the display unit to the outside of the visible field while keeping the specific object, which is required not to be seen by the user when positioned outside the visible field, from being seen by the user. Furthermore, the user can separately identify the part of the visible field and the part of the adjacent field in the displayed area of the virtual field to be displayed at the display unit. That is, the user can separately identify an area (the visible field) where the specific object located therein can be seen and an area (the adjacent field) where the specific object located therein cannot be seen, in the displayed area of the virtual field.

Accordingly, it is possible to expand the displayed area of the virtual field to be displayed at the display unit to the outside of the visible field while keeping the specific object positioned outside the visible field from being seen by the user.

In addition, an example of a field differentiation process other than the image processing for superimposing a mask image such as in the above image display control device is image processing for displaying the visible field in a color image and displaying the adjacent field in a monochrome image.

In addition, in the above image display control device, the location decision unit may change location of the specific object according to a predetermined location changing condition, and the display control unit may execute display control to move the image of the specific object positioned in the adjacent field to the visible field and execute the opacifying process such that the image of the specific object gradually changes from a transparent state to an opaque state, when the location decision unit changes location of the specific object from the adjacent field to the visible field.

In the present image display control device in which the location of the specific object in the virtual field is changed, the image of the specific object is displayed at the display unit so that the specific object is moving in the virtual field. Here, the image of the specific object is transparent and is not displayed when positioned in the adjacent field, and becomes opaque and is displayed when positioned in the visible field. When such a specific object moves from the adjacent field to the visible field and the transparent image of the specific object becomes opaque instantaneously, the user feels as if the specific object suddenly appears in the virtual field although the specific object has been located in the virtual field. In contrast, regarding the present image display control device, when the transparent specific object positioned in the adjacent field moves to the visible field, the image of the specific object gradually changes from the transparent state to the opaque state. This can reduce the feeling of the user that the specific object suddenly appears in the virtual field. Accordingly, uncomfortable feeling of the user can be reduced.

In addition, in the above image display control device, the location decision unit may change location of the specific object according to a predetermined location changing condition, and the display control unit may execute display control to move the image of the specific object positioned in the visible field to the outside of the visible field and execute the transparentizing process such that an image of the specific object gradually changes from an opaque state to a transparent state, when the location decision unit changes location of the specific object from the visible field to the outside of the visible field.

In the present image display control device in which the location of the specific object in the virtual field is also changed, the image of the specific object is displayed at the display unit so that the specific object is moving in the virtual field. Here, the image of the specific object is displayed in the opaque state when positioned in the visible field. However, if such a specific object moves from the visible field to the outside of the visible field and the opaque image of the specific object becomes transparent instantaneously, the user feels as if the specific object suddenly disappears from the inside of the virtual field. On the contrary, regarding the present image display control device, when the opaque specific object positioned in the visible field moves to the outside of the visible field, the image of the specific object gradually changes from the opaque state to the transparent state. This can reduce the feeling of the user that the specific object suddenly disappears from the inside of the virtual field. Accordingly, uncomfortable feeling of the user can be reduced.

As another aspect of the present invention, it is listed that a game machine includes: a game screen display unit for displaying a game screen; an operation acceptance unit for accepting an operation by a player; a game control unit for causing a computer to execute a predetermined game execution program so as to control procession of a game according to content of a game operation accepted by the operation acceptance unit; and an image display control unit for executing display control to display, at the game screen display unit, a game screen corresponding to procession of the game controlled by the game control unit, wherein the above image display control device is used as the image display control unit, and the location decision unit of the image display control device decides location of various objects in the virtual field according to control content of procession of the game by the game control unit.

In the present game apparatus, the game proceeds when the game operation by the player (user) is accepted by the operation acceptance unit, and the location of the object in the virtual field is decided in accordance with procession of the game. The image of the object located in the visible field as described above is displayed at the display unit. Moreover, when the specific object is positioned at least in the adjacent field adjacent to the visible field on the outside of the visible field, the image of this specific object is transparent. Accordingly, it is possible to reliably prevent the image of the specific object positioned outside the visible field from being seen by the player, without complicating a decision process regarding the location of a specific object in the virtual field. Consequently, it is possible to ensure the game attractiveness generated by limiting the visible field.

As another aspect of the present invention, it is listed that a program for causing a computer of an image display control device, which includes an image information storage unit for storing image information necessary for displaying, at a display unit, an image of various objects located in a virtual field constituted of a two-dimensional virtual plane or a three-dimensional virtual space, to operate, wherein the program causes the computer to function as: a location decision unit for deciding location of various objects in the virtual field; and a display control unit for executing display control to display, at the display unit, an image of the object located in a visible field, which is a part of the virtual field, in a state where the visible field is viewed from a predetermined viewpoint direction, based on location of the objects decided by the location decision unit and image information stored in the image information storage unit, a transparentizing process for transparentizing an image of a specific object located in the virtual field by the location decision unit when the specific object is positioned at least in an adjacent field adjacent to the visible field on the outside of the visible field, and an opacifying process for opacifying an image of the specific object when the specific object is positioned in the visible field.

In addition, as another aspect of the present invention, it is listed that a recording medium having the above program.

When the specific object located in the virtual field is positioned at least in the adjacent field adjacent to the visible field on the outside of the visible field, the image of this specific object becomes transparent by executing the present program with the computer of the image display control device. Accordingly, it is possible to reliably prevent the image of the specific object positioned outside the visible field from being seen by the user without complicating a decision process of the location of the specific object in the virtual field.

### EFFECT OF THE INVENTION

As described above, According to the present invention, it becomes possible to reliably prevent the specific object, which is required not to be seen by the user when positioned outside the visible field, among various objects located in the virtual field, from being seen by the user when the specific object is positioned outside the visible field, in a easy method.

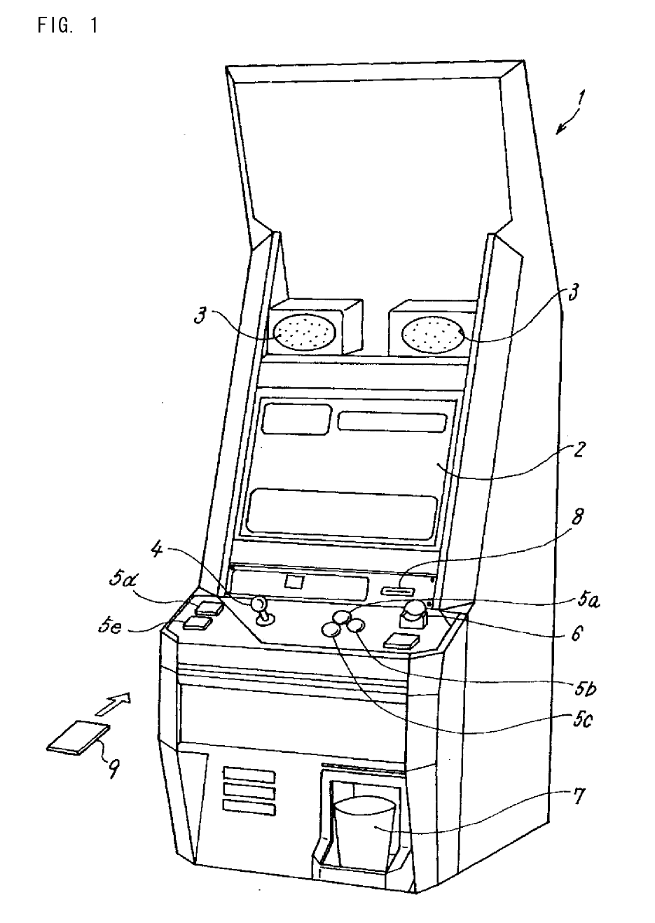

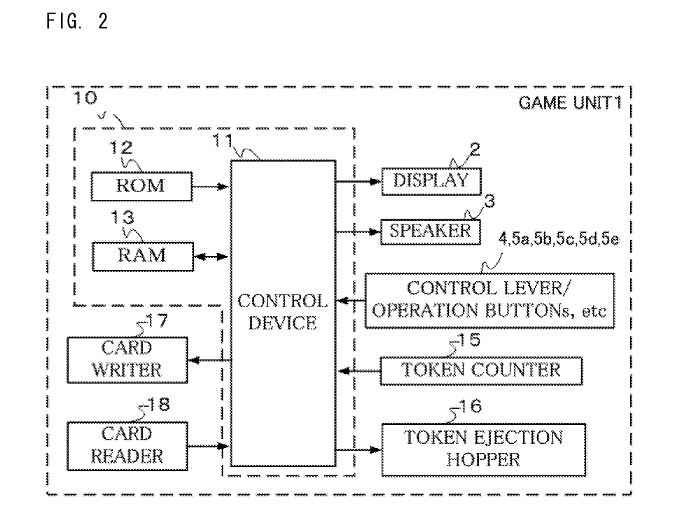

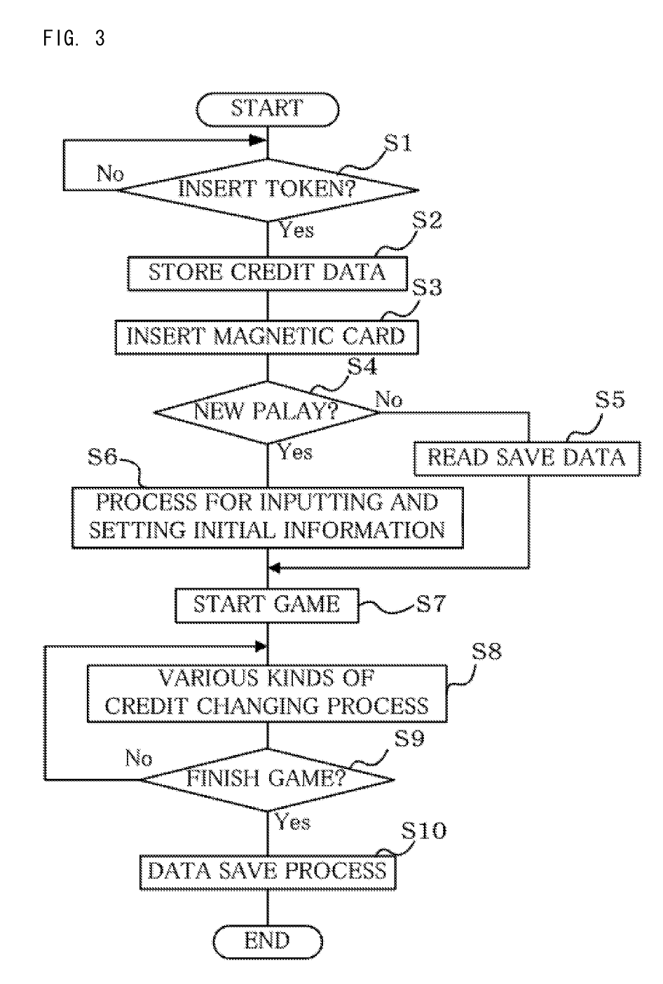

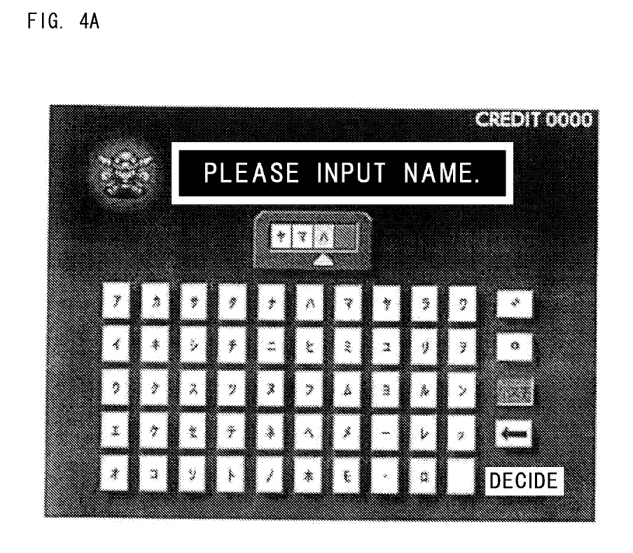

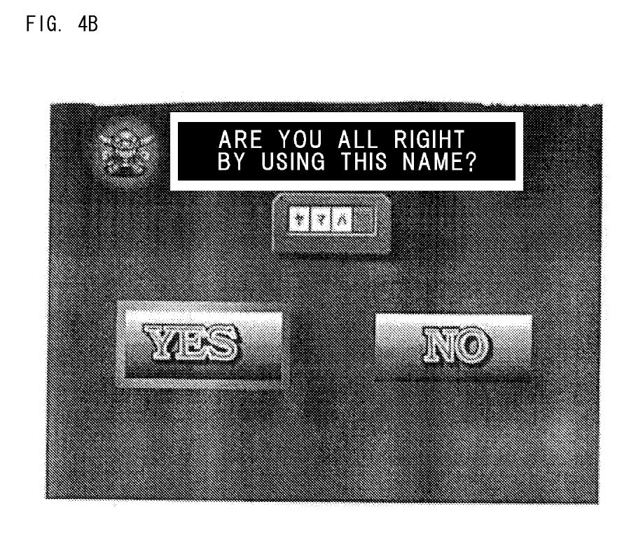

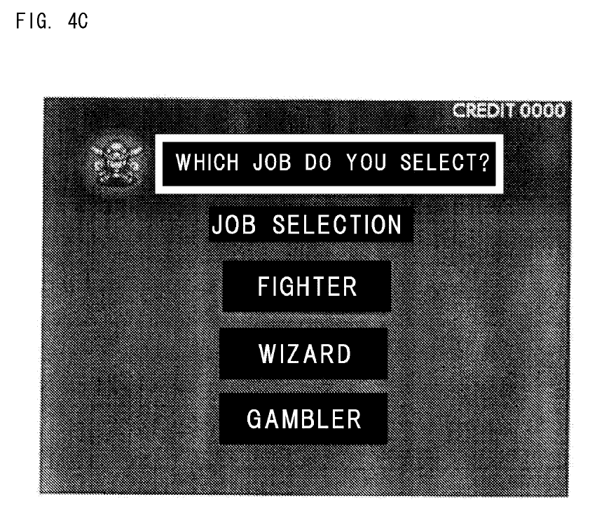

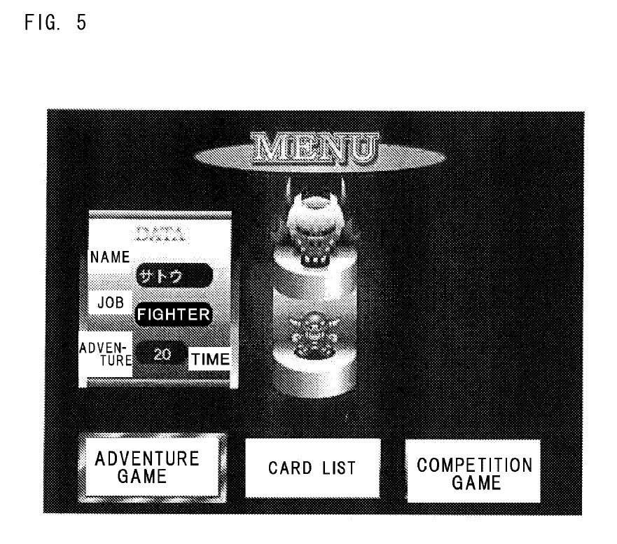

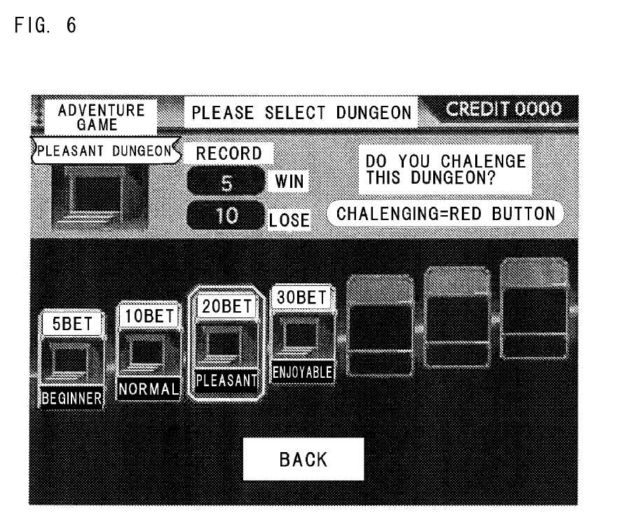

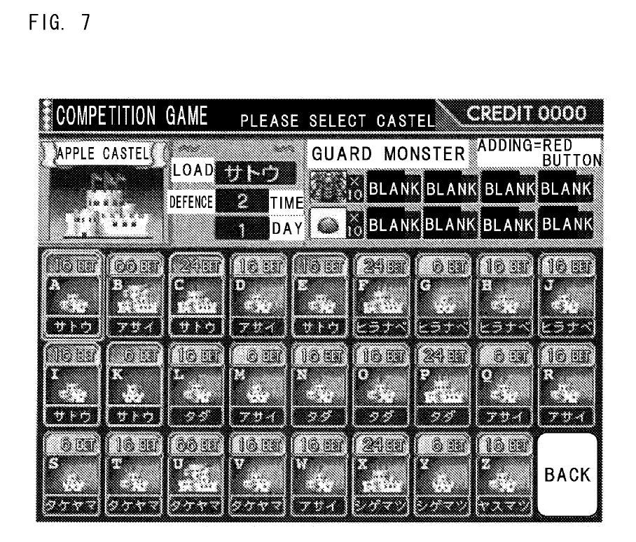

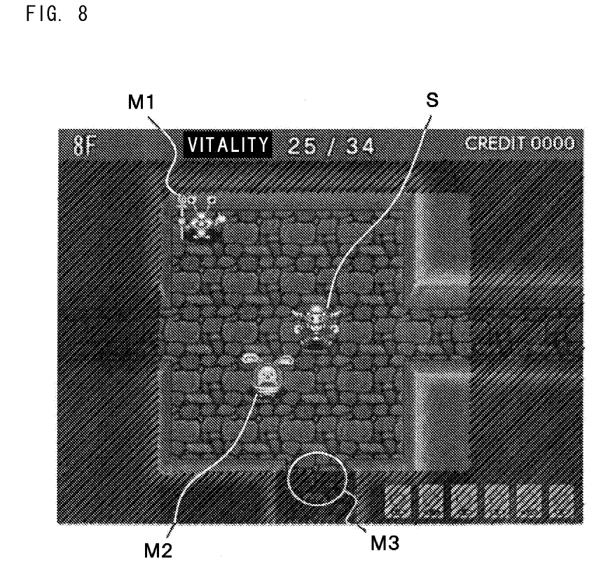

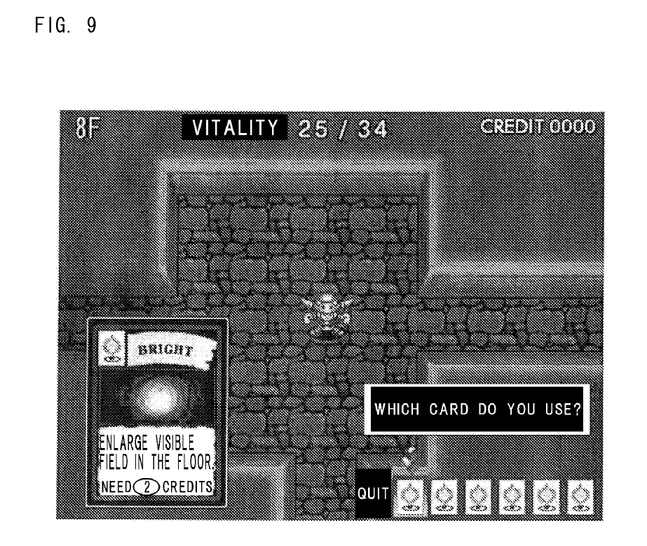

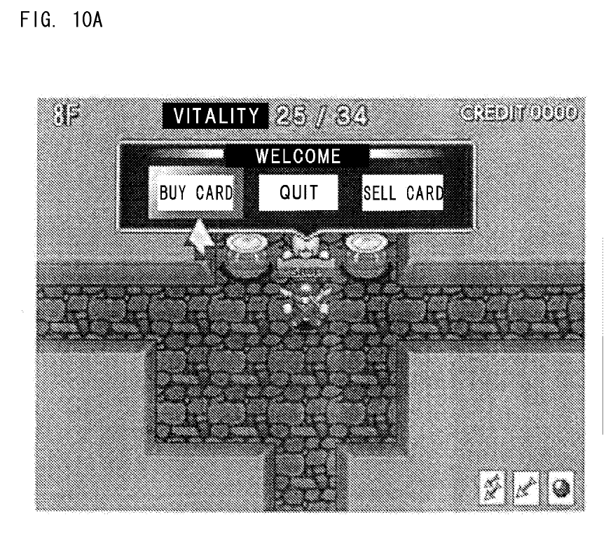

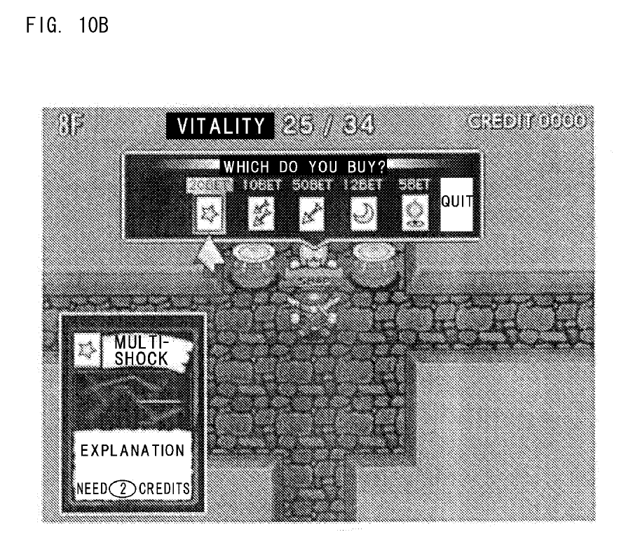

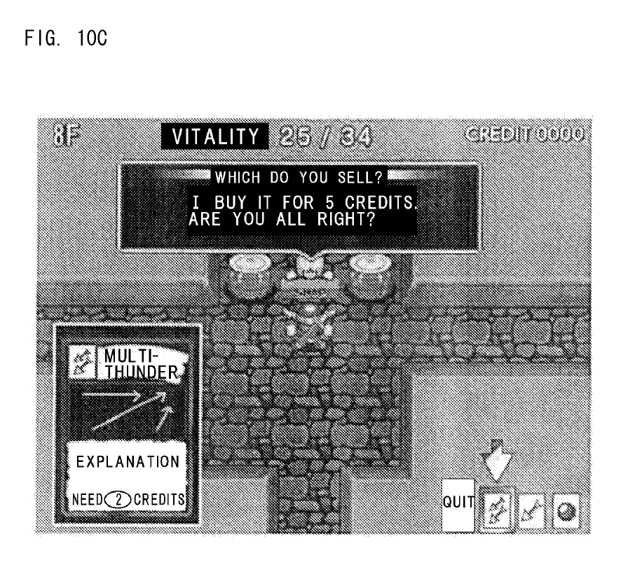

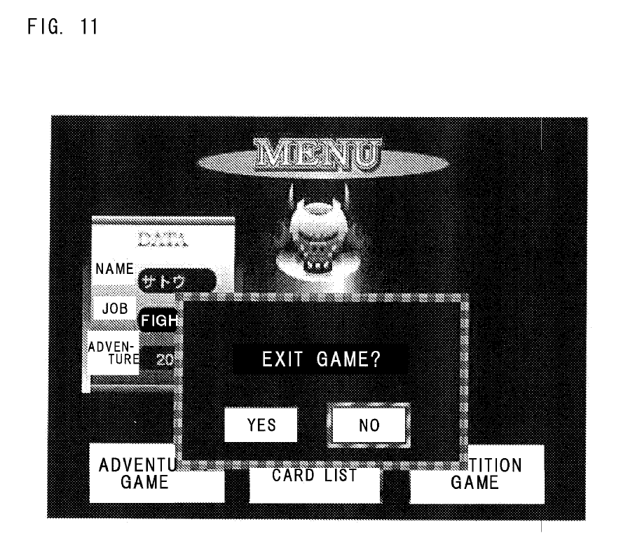

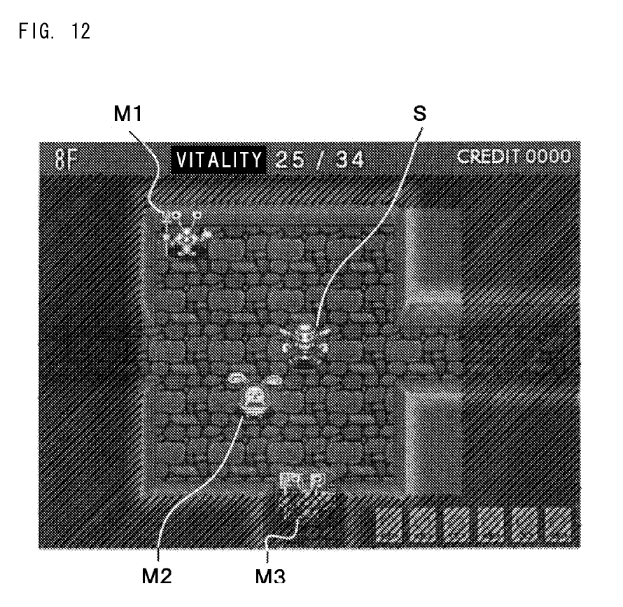

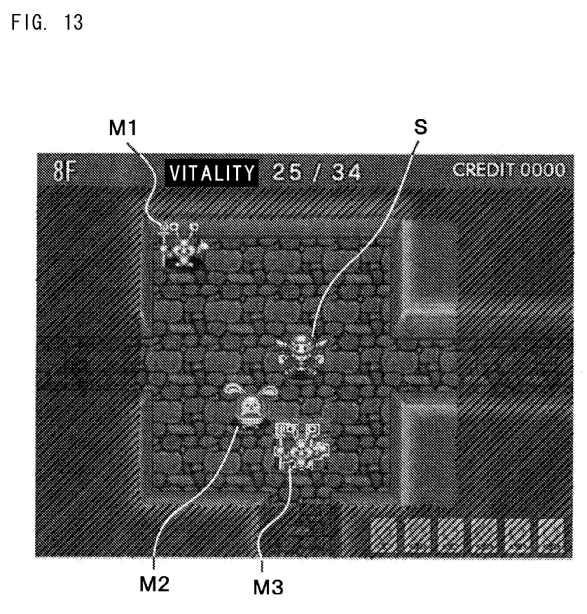

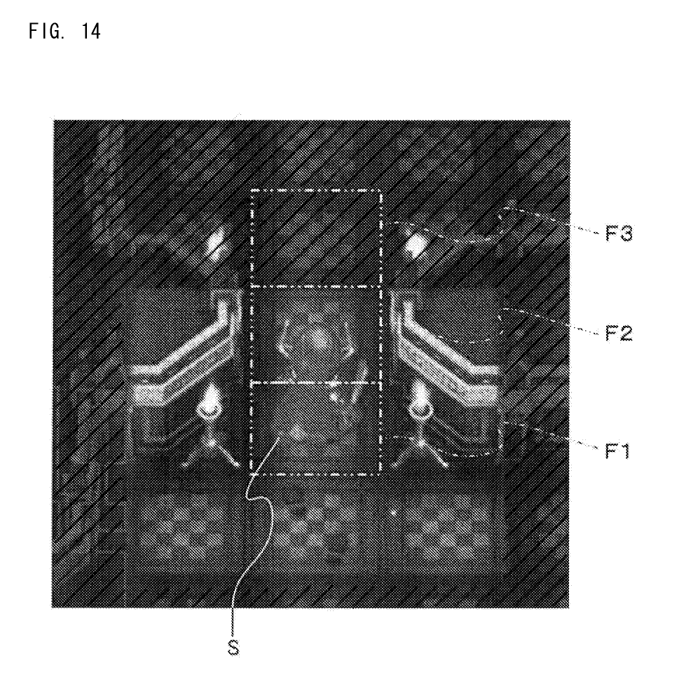

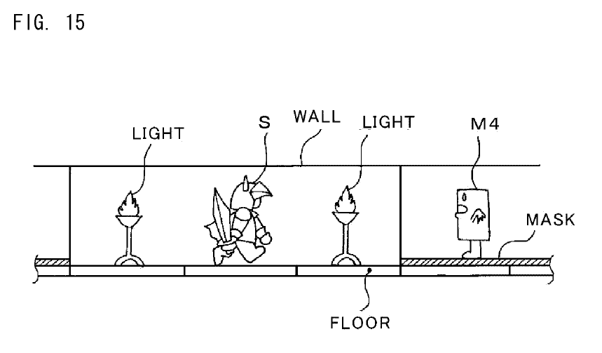

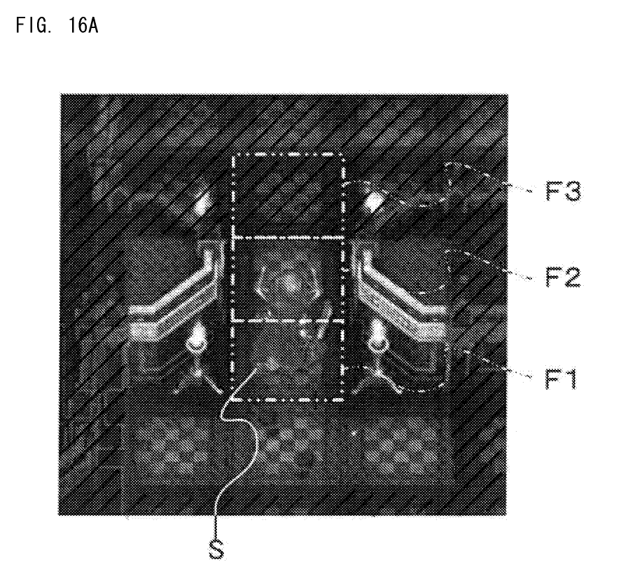

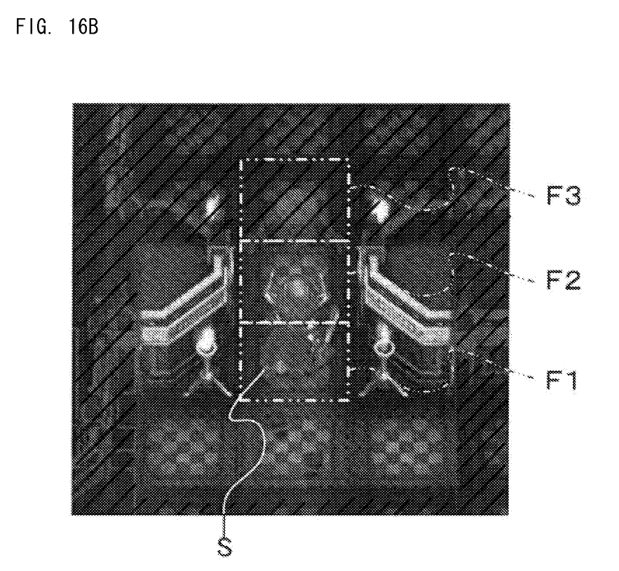

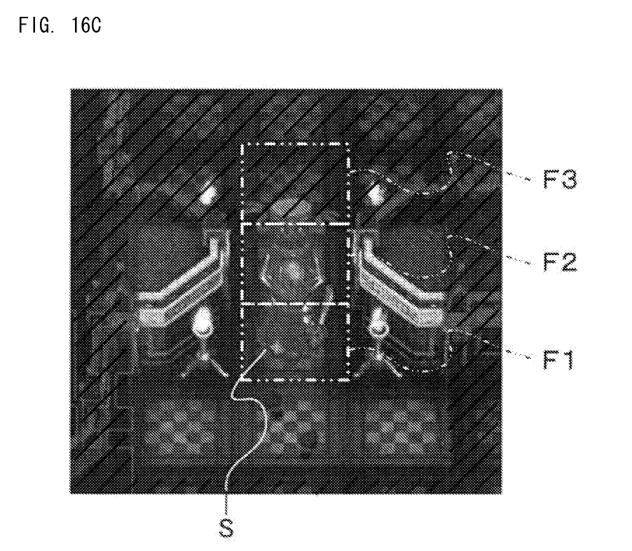

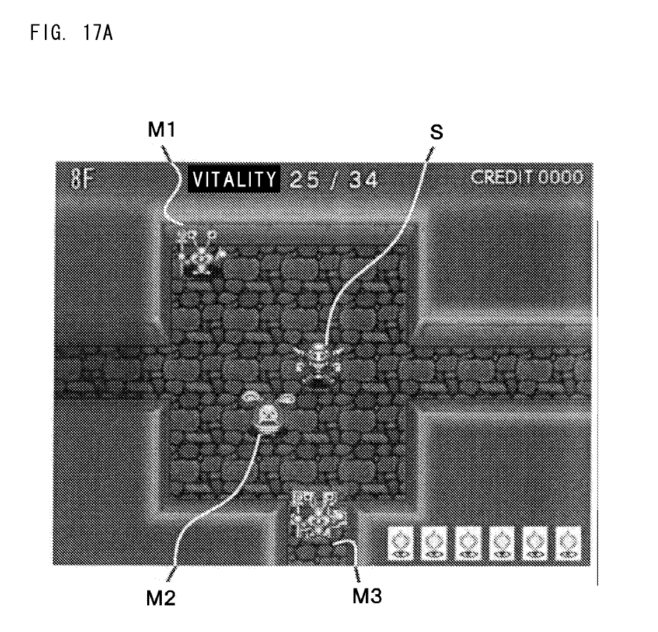

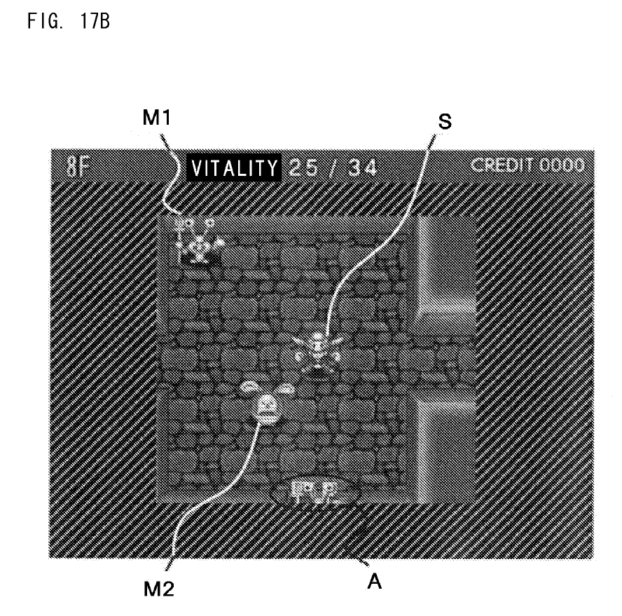

### BRIEF DESCRIPTION OF DRAWINGS

[FIG. 1] FIG. 1 is an outside view of a token-operated game machine according to the embodiment.

[FIG. 2] FIG. 2 is a block diagram showing the main structure of a control system of the token-operated game machine.

[FIG. 3] FIG. 3 is a flowchart showing the flow of game procession control by a control device 11 for executing a game execution program.

[FIG. 4A] FIG. 4A is an explanatory view of a name input screen to be displayed at a display of the token-operated game machine.

[FIG. 4B] FIG. 4B is an explanatory view of a name confirmation screen to be displayed at the display of the token-operated game machine.

[FIG. 4C] FIG. 4C is an explanatory view of a job selection screen to be displayed at the display of the token-operated game machine.

[FIG. 5] FIG. 5 is an explanatory view of a main menu screen to be displayed at the display of the token-operated game machine.

[FIG. 6] FIG. 6 is an explanatory view of a dungeon selection screen to be displayed at the display of the token-operated game machine.

[FIG. 7] FIG. 7 is an explanatory view of a castle selection screen to be displayed at the display of the token-operated game machine.

[FIG. 8] FIG. 8 is an explanatory view of a game screen to be displayed at the display of the token-operated game machine.

[FIG. 9] FIG. 9 is an explanatory view of a card selection screen to be displayed at the display of the token-operated game machine.

[FIG. 10A] FIG. 10A is an explanatory view of a shop screen to be displayed at the display of the token-operated game machine.

[FIG. 10B] FIG. 10B is an explanatory view of a card selection screen in which a list of cards which can be bought at the shop screen is displayed.

[FIG. 10C] FIG. 10C is an explanatory view of a card selection screen in which a list of cards which can be sold at the shop screen is displayed.

[FIG. 11] FIG. 11 is an explanatory view of a game exit selection screen to be displayed at the display of the token-operated game machine.

[FIG. 12] FIG. 12 is an explanatory view of a game screen to be displayed when a transparentizing process is not executed in the same game situation as the game screen illustrated in FIG. 8.

[FIG. 13] FIG. 13 is an explanatory view of a game screen in a game situation one turn after the same game situation as the game screen illustrated in FIG. 8.

[FIG. 14] FIG. 14 is an explanatory view in which a part of a castle screen to be displayed at a display in a token-operated game machine of a modification example is enlarged.

[FIG. 15] FIG. 15 is an explanatory view showing a schematic image of each object in a state where a central character S is viewed from a direction parallel to the floor, which is the right side in FIG. 14, in the same game situation as the game screen illustrated in FIG. 14.

[FIG. 16A] FIG. 16A is an explanatory view showing an image of an enemy monster when the location of this enemy monster is changed from a division F3 to a division F2.

[FIG. 16B] FIG. 16B is also an explanatory view showing the image of the enemy monster when the location of this enemy monster is changed from the division F3 to the division F2.

[FIG. 16C] FIG. 16C is also an explanatory view showing the image of the enemy monster when the location of this enemy monster is changed from the division F3 to the division F2.

[FIG. 17A] FIG. 17A is an explanatory view showing an example of a conventional game screen of a dungeon constituted of a two-dimensional virtual plane.

[FIG. 17B] FIG. 17B is an explanatory view showing a game screen when a mask image is superimposed on the game screen of FIG. 17A.

[FIG. 17C] FIG. 17C is an explanatory view showing a game screen when a visible field in the game screen of FIG. 17B is displayed over the entire displayed area.

[FIG. 18A] FIG. 18A is an explanatory view for schematically representing an example of a conventional game screen when a dungeon is constituted of a three-dimensional virtual space and a viewpoint direction is parallel to the normal direction of the dungeon floor.

[FIG. 18B] FIG. 18B is an explanatory view for schematically representing an example of a game screen when a viewpoint direction is inclined to the normal direction of the dungeon floor.

### DESCRIPTION OF REFERENCE NUMERALS

1: Token-operated game Machine

2: Display

4, 5a, 5b, 5c, 5d, 5e: Control Lever/Operation Buttons and the like

11: Control Device

F1, F2, F3: Divisions

M1, M2, M3, M4: Enemy Monsters

S: Central Character

### BEST MODE FOR CARRYING OUT THE INVENTION

The following description will explain the present invention with reference to an embodiment applied to a token-operated game machine which is an arcade game machine as a game apparatus.

In the token-operated game machine according to the present embodiment, the player (user) carries out an operation to give an instruction on the operation of a game central character S (hereinafter referred to as “a central character S”), which is an operational object, so that a role-playing game aimed at causing the central character S to move inside a castle, which is a virtual field, and to occupy the castle is developed. Since an enemy monster (specific object), which is an object preventing ahead of the central character S, appears in the castle, the player carries out an operation to give such an instruction on the operation of the central character S that the central character S can move in the castle without being brought down by the enemy monster and gain a jewel (proof of clearing), which is an object to be proof of occupying the castle. The central character S to be operated by the player moves in the castle while attacking the enemy monster or using various kinds of item cards or magic cards (objects), which are game situation changing elements, in order to oppose the enemy monster, and tries to gain the proof of clearing. If the central character S gains the proof of clearing and succeeds in occupying the castle, the player can be the lord of the occupied castle, and the player who has become the lord can participate in a kind of a competition game with another player who tries to occupy the player's castle.

Next, the structure of the token-operated game machine according to the present embodiment will be explained.

FIG. 1 is an outside view of a token-operated game machine 1 according to the present embodiment.

The token-operated game machine 1 is provided with a display 2, which is a display unit functioning as display means for displaying a game screen corresponding to procession of a game; speakers 3 for outputting a sound such as a sound effect or background music corresponding to procession of the game; a control lever 4 and three operation buttons 5a, 5b, 5c which constitute an operation acceptance unit functioning as operation acceptance means for accepting a game operation including an operation by the player for giving an instruction on movement of the central character S that appears on the game screen; a payout button 5d for paying back a token (tangible object), which is a game medium to be transferred between the token-operated game machine 1 and the player, to the player; and a save/exit button 5e for ejecting a magnetic card, which will be described later, and exiting the game.

The player operates the control lever 4 and the three operation buttons 5a, 5b, 5c while looking at a game screen to be displayed at the display 2 so as to, for example, give an instruction on which direction the central character S that appears on the game screen is to be moved, or an instruction on which item card is to be used. In addition, the token-operated game machine 1 is also provided with a token insert slot 6 for receiving tokens in a state of tangible objects from the player; a token payback slot 7 for paying back tokens to the player; a card insert/eject slot 8 for inserting or ejecting the magnetic card 9, on which personal information of the player, the game situation at the time of exiting or the like is recorded so that the player who has exited the game can play the continuation of the game at the next time of play; and the like.

FIG. 2 is a block diagram showing the main structure of a control system of the present token-operated game machine.

A control unit 10 of the token-operated game machine 1 functions as an image display control device, and is mainly composed of a control device 11, a ROM 12 and a RAM 13. The control device 11 executes various programs, which are stored in the ROM 12, so as to carry out various controls. Specifically, the control device 11 executes a game execution program stored in the ROM 12 with a computer provided therein, so as to carry out various controls necessary for procession of the role-playing game described above. The ROM 12 stores an execution program or the like of various controls to be performed by the control unit 10 of the token-operated game machine 1. Specifically, the ROM 12, which is an image information storage unit according to the present embodiment, stores image information or the like necessary for displaying, at the display 2, the images of various objects located in the castle or a dungeon, which is a virtual field, and functions as image information storage means. The RAM 13 temporarily stores various data or information. Specifically, the RAM 13 has a credit data storage area, which is a player point storage unit functioning as player point storage means for storing credit data (point data) that is a game medium to be obtained by converting the number of tokens counted by a token counter 15 into electronic data, the token counter 15 being described later.

The control unit 10 of the token-operated game machine 1 is connected with the display 2; the speakers 3; the control lever, the operation buttons and the like 4, 5a, 5b, 5c, 5d, 5e; the token counter 15 for counting the number of tokens inserted into the token insert slot 6; a token ejection hopper 16 for ejecting tokens from the token payback slot 7; a card writer 17, which is a data writing unit functioning as data writing means for writing data on the magnetic card 9 inserted into the card insert/eject slot 8; a card reader 18, which is a data reading unit functioning as data reading means for reading data from the magnetic card 9 inserted into the card insert/eject slot 8; and the like.

In the present token-operated game machine 1, in order to exit the game, the player makes the card writer 17 record save data, which is game situation information to be used for restoring the game situation at the time of exiting at the restart of the next game, on the magnetic card 9. The save data includes player information such as a player name (name of the central character S), an accumulated playing time, the last playing time, the name of cleared dungeons, the name of castles where the central character S is the current lord, ability (job or the like) of the central character S, and the sort of item cards, which are usable elements among game situation changing elements owned by the player; and game information such as the sort of dungeons or castles where the central character S exists at the time of exiting from the game, and field data such as the position of the central character S, enemy monsters or ungained item cards in the dungeon or the castle. On the other hand, in order to play the continuation of the game which the player has exited once, the player inserts own magnetic card 9 into the card insert/eject slot 8. This makes the card reader 18 read save data recorded on the magnetic card 9. The save data is stored in the RAM 13 and is loaded into the game execution program stored in the ROM 12. Thereby, the player can restart to play from a game situation of the continuation of the last play of the game to be caused to proceed by the control device 11, which is a game control unit functioning as game control means for executing the game execution program.

In addition, it is unnecessary to record all save data on the magnetic card 9 and, for example, it is possible to record a player ID (card ID), which is player identification information, on the magnetic card 9 and store a part of or all of save data corresponding to each player ID in a storage device in the present token-operated game machine 1 or in an external storage device connected with the present token-operated game machine 1. In such a case, the player can restart to play from a game situation of the continuation of the last play as in the above description, by reading the player ID from the magnetic card 9 and then downloading save data corresponding to the player ID from the corresponding storage device to the RAM 13 of the token-operated game machine 1.

Next, the flow of the game to be played in the present token-operated game machine 1 will be explained.

FIG. 3 is a flowchart showing the flow of game procession control by the control device 11 for executing the game execution program stored in the ROM 12 of the present token-operated game machine 1.

In order to start playing the game, the player first injects some of own tokens into the token insert slot 6 (S1). This causes the token counter 15 to count the number of inserted tokens, and the count data is transmitted to the control device 11. The control device 11 stores credit data corresponding to the number of inserted tokens in a credit data storage area of the RAM 13 on the basis of the received count data (S2).

Moreover, the player inserts the magnetic card 9 into the card insert/eject slot 8 before or after inserting the tokens (S3). For the first play, the player gets a new magnetic card 9 from an attendant or an automatic dispenser in an amusement arcade where the present token-operated game machine 1 is placed and inserts the magnetic card 9 into the card insert/eject slot 8. On the other hand, in order to play the continuation of the last play of the game, the player inserts the magnetic card 9, on which save data at the time of exiting from the last play is recorded, into the card insert/eject slot 8. When receiving the magnetic card 9 as described above, the token-operated game machine 1 causes the card reader 18 to read out data recorded on the magnetic card 9 and transmits the data to the control device 11. The control device 11 decides whether a play to be started is a new play or not on the basis of the received data (S4). Concretely, it is decided that a play to be started is a new play when no player ID is stored in the magnetic card 9, and it is decided that a play to be started is not a new play when a player ID is stored.

When it is decided in the S4 that a play to be started is not a new play, the card reader 18 reads out save data recorded on the magnetic card 9 (S5) and the save data is stored in the RAM 13. The control device 11 then loads programs stored in the ROM 12 on the basis of the save data, displays, at the display 2, a game screen corresponding to a game situation of the continuation of the last play to be specified by the save data, and starts the game (S7). The control device 11 then controls procession of the game after the game situation to be specified by the save data.

On the other hand, when it is decided in the step S4 that a play to be started is a new play, the control device 11 executes a process for inputting and setting initial information (S6). In the process for inputting and setting initial information, a name input screen illustrated in FIG. 4A is first displayed at the display 2. The player operates the control lever 4 and the operation button 5a to move a cursor on Japanese syllabary buttons displayed on the name input screen so as to input the name of the central character S. After inputting the name and selecting a decision button on the name input screen, a name confirmation screen illustrated in FIG. 4B is displayed, and a name is decided by selecting the Yes button in the screen. A job selection screen illustrated in FIG. 4C is then displayed at the display 2. On this screen, the job of the central character S operated by the player is selected. The control device 11 stores the content of input or the content of selection described above in the RAM 13 as player information.

When the process for inputting and setting initial information is completed as described above, the control device 11 starts the game (S7) and displays a main menu screen illustrated in FIG. 5 at the display 2. The main menu screen is provided with an adventure game button for making an adventure in the dungeon; a competition game button for making an attempts at the castle owned by another player; and a card list button for displaying a list of item cards or magic cards which can be used by the player during these games. On this screen, the player selects playing the adventure game or playing the competition game.

Here, when the player selects the adventure game, the control device 11 displays a dungeon selection screen illustrated in FIG. 6 at the display 2 and executes a dungeon selection process. On this dungeon selection screen, an image to be used for selecting each dungeon is displayed. The player then moves a cursor with the control lever 4 so as to select a dungeon for making an attempt. On each displayed image, the respective dungeon names and the number of tokens necessary for making an attempt (attempt cost) are displayed. In each dungeon, a game originating from the dungeon name is developed, and these games different from each other proceed. When the player selects, for example, a pleasant dungeon, the selected dungeon is displayed at an upper part of a screen illustrated in the figure. Then, when deciding to make an attempt at the selected dungeon, the player pushes the operation button 5a. When accepting the button operation, the control device 11 decreases the credit data stored in the RAM 13 by an amount of the corresponding attempt cost.

Concretely, the ROM 12 of the token-operated game machine 1 has a data area for storing a dungeon information database storing dungeon data, which is game information necessary for procession of the game at each dungeon. In the dungeon information database, attempt cost data is stored respectively in accordance with dungeon name data for specifying dungeon data. When accepting a selection operation (dungeon selection operation) by the player for selection of a dungeon at the dungeon section screen illustrated in FIG. 6, the control device 11 specifies dungeon name data corresponding to the selection operation in the dungeon information database and reads out attempt cost data corresponding to the dungeon name data. The control device 11 then executes a process for decreasing a credit amount corresponding to the read-out attempt cost data from the credit data stored in the RAM 13. In addition, a process for increasing or decreasing the credit data is also executed hereinafter as in the above description.

Here, when the credit data stored in the RAM 13 is less than the credit amount corresponding to the attempt cost data, a screen to prompt the player to insert additional tokens is displayed. When tokens are inserted, credit data corresponding to the number of inserted tokens is stored in the credit data storage area of the RAM 13 as described above. In addition, making an attempt at the castle is not permitted when no token is inserted after the player is prompted to insert tokens. The player is also prompted to insert tokens hereinafter as in the above description when a process for decreasing the credit data is executed.

In addition, when accepting the dungeon selection operation, the control device 11 reads out dungeon data corresponding to the dungeon name data from the dungeon information database. The control device 11 then loads a program based on the dungeon data and displays a game screen based on the dungeon data at the display 2.

On the other hand, when the player selects the competition game at the main menu screen illustrated in FIG. 5, the control device 11 displays a castle selection screen illustrated in FIG. 7 at the display 2 and executes a castle selection process. On the castle selection screen, an image to be used for selecting each castle is displayed. The player then moves a cursor with the control lever 4 so as to select a castle for making an attempt. On each displayed image, each castle name and an attempt cost are displayed. These games different from each other proceed in the respective castles. In addition, the lord of each castle is a player who has succeeded in occupying the castle in the past, and the player is to compete against a player who is the current lord.

Concretely, the ROM 12 of the present token-operated game machine 1 has a data area for storing a castle information database storing castle data, which is game information necessary for procession of a game at each castle. Castle name data included in the castle data stored in the castle information database is associated with a lord ID (ID of a player who is the current lord), which is player identification information.

When accepting a button operation carried out by the player for selecting a competition game at the main menu screen illustrated in FIG. 5, the control device 11 of the token-operated game machine 1 returns image data, which is to be used for displaying the castle selection screen illustrated in FIG. 7 at the display 2 of the token-operated game machine 1. Moreover, when accepting a selection operation for selecting a castle, for which the player is to make an attempt, at the castle selection screen displayed at the display 2, the control device 11 reads out castle data corresponding to the castle name data of a castle according to the selection operation from the castle information database stored in the ROM 12. The control device 11 then loads a program based on the castle data and controls procession of the game.

In addition, the ROM 12 of the token-operated game machine 1 has a data area for storing a castle attempt information database respectively storing attempt cost data in association with the castle name data for specifying each castle data. When accepting a selection operation of a castle selected at the castle selection screen illustrated in FIG. 7 as described above, the control device 11 reads out attempt cost data corresponding to the castle name data from the castle attempt information database stored in the ROM 12 as in the above adventure game and performs a process for decreasing a credit amount corresponding to the attempt cost data from the credit data stored in the RAM 13.

When a game is started in such a manner, the control device 11, which is a display control unit, functions as display control means to display a game screen as illustrated in FIG. 8 at the display 2. In addition, the game screen to be displayed is almost the same in an adventure game and in a competition game and how a game proceeds is also the same, therefore, the following description will explain only a competition game as an example.

By operating the control lever 4 and the operation buttons 5a, 5b, 5c, the player can give an instruction to move the central character S, to attack enemy monsters M1, M2, M3, or to use an item card or a magic card which he/she owns. The present embodiment adopts a turn system, and it is possible to give an instruction on one action for each turn. Consequently, for example, to move the central character S by one division requires one turn, to attack the enemy monsters M1, M2, M3 by the central character S one time requires one turn, and to use one card by the central character S requires one turn. In addition, the turn does not proceed as long as the player does not carry out a game operation which consumes a turn. On the other hand, when the turn proceeds, the enemy monsters M1, M2, M3 also move similar to the central character S or attack the central character S, and the game situation changes. Vitality of the central character S is decreased when receiving an attack from the enemy monsters M1, M2, M3, and the game is over when the vitality of the central character S becomes zero.

In order to use an item card or a magic card owned by the central character S, the player pushes the operation button 5c. When accepting the operation, the control device 11 displays a card selection screen illustrated in FIG. 9 at the display 2. On the card selection screen, a cursor appears on a card list which exists at the lower right part of the screen. In addition, on the card selection screen, a card content screen for illustrating the content of a card selected by the cursor is displayed at the left part of the screen. On the card content screen, the effect (how the game situation is changed) after usage of the card and the number of tokens necessary for using the card (card usage cost) is displayed. The player moves the cursor with the control lever 4 to select a card which he/she wants to use, and then pushes the operation button 5a. When accepting the button operation (special operation), the control device 11 determines that a predetermined point consumption condition has been satisfied, and executes a credit changing process (player point subtraction process) for varying the credit data stored in the RAM 13 so as to be decreased by an amount corresponding to the card usage cost of the selected card (S8).

More specifically, the RAM 13 of the token-operated game machine 1 stores a card database having a usable data area as a usable element storage unit, which functions as usable element storage means for storing card data of cards in a usable state for the central character S among various card data; and an unusable data area as an unusable element storage unit, which functions as unusable element storage means for storing card data of cards in an unusable state for the central character S. Each card data stored in the card database has various data associated with card name data. A readout permission code for enabling readout by a card usage program to be executed by the control device 11 is added to card data of cards usable for the central character S, and a usable data area to be a usable element storage unit storing card data to which the readout permission code is added functions as usable element storage means. On the other hand, an unusable data area to be an unusable element storage unit storing card data to which the readout permission code is not added functions as unusable element storage means. In addition, a card displayed on the game screen of FIG. 8 or the card selection screen of FIG. 9 corresponds to card data as a usable element stored in the usable data area.

When accepting an operation for instructing the central character S to use a card at the card selection screen illustrated in FIG. 9, the control device 11 identifies a card name based on the instruction. The control device 11, which is a usage decision unit, then functions as usage decision means when the credit data stored in the RAM 13 is equal to or more than card usage cost data, and decides to use card data corresponding to the card name data. The control device 11, which is a game situation changing unit, then functions as game situation changing means to read out card effect data corresponding to the corresponding card name data from the card database and to change the game situation on the basis of the card effect data. For example, when the used card is a magic card for attacking the enemy monsters M1, M2, M3, the control device 11 performs a process of using a damage computation value included in the card effect data for computing the damage to the enemy monsters M1, M2, M3 and decreasing vitality data of the enemy monsters M1, M2, M3 on the basis of the computation result.

In addition, when deciding to use the card data, the control device 11 selects card name data from the card database and reads out card usage cost data corresponding to the card name data. The control device 11 then performs a process for decreasing credit data corresponding to the read-out card usage cost data from credit data stored in the RAM 13.

In addition, a magic card or an item card available for the central character S is located in a castle. The player can gain a magic card or an item card by operating the movement of the central character S to move the central character S to the position of the card.

In addition, a shop illustrated in FIG. 10A where a card can be sold or bought is prepared in a castle. When the player operates the movement of the central character S to move the central character S and cause the central character S to enter the shop, a card owned by the central character S can be sold or changed to credit, or a card sold at the shop can be bought by paying credit.

In order to buy a card at the shop, the player operates the control lever 4 at a shop screen illustrated in FIG. 10A, moves the cursor to a “Buy Card” button, and pushes the operation button 5a. When accepting the operation, the control device 11 displays a card selection screen for buying illustrated in FIG. 10B at the display 2. On the card selection screen for buying, a card list screen of cards sold at the shop is displayed at an upper part of the screen and a card content screen for illustrating the content of a card selected with the cursor is displayed at the lower left part of the screen. The number of tokens necessary for buying a card (card buy cost) is displayed on the card list screen. The player moves the cursor with the control lever 4 to select a magic card which he/she wants to buy and then pushes the operation button 5a. When accepting the button operation (special operation), the control device 11 determines that a predetermined point consumption condition has been satisfied, and executes a credit changing process (player point subtraction process) for varying the credit data stored in the RAM 13 so as to be decreased by an amount corresponding to the card buy cost of the card (S8).

More specifically, the card database also stores card buy cost data associated with card name data. When accepting an operation for selecting a card to buy at the card selection screen for buying illustrated in FIG. 10B, the control device 11 identifies card name data of the card. Moreover, when the credit data stored in the RAM 13 is equal to or more than the card buy cost data, the control device 11 adds a usage permission code to card data corresponding to the corresponding card name data so as to set the corresponding card data existing in an unusable data area of the card database to a usable state. Thereby, the card data is stored in the usable data area of the card database and becomes usable for the central character S by means of an instruction operation by the player. In addition, when permitting usage of card data existing in the unusable data area, the control device 11 selects the corresponding card name data from the card database and reads out card buy cost data corresponding to the card name data. The control device 11 then performs a process for subtracting credit data corresponding to the read-out card buy cost data from the credit data stored in the RAM 13.

On the other hand, in order to sell a card owned by the central character at the above shop, the player operates the control lever 4 to move the cursor to a “Sell Card” button and pushes the operation button 5a on the shop screen illustrated in FIG. 10A. When accepting the operation, the control device 11 displays a card selection screen for selling illustrated in FIG. 10C at the display 2. At the card selection screen for selling, a cursor appears on a card list existing at the lower right part of the screen and a card content screen for illustrating the content of a card selected with the cursor is displayed at the left part of the screen. In addition, a selling price screen for representing the number of tokens (card sell income) to be exchanged with a selected card is displayed at the upper part of the card selection screen for selling. The player moves the cursor with the control lever 4 to select a card to sell from cards owned by the central character, and pushes the operation button 5a. When accepting the button operation, the control device 11 executes a credit changing process for varying the credit data stored in the RAM 13 so as to be increased by an amount corresponding to a card sell income of the card (S8).

More specifically, the card database also stores card sell income data associated with card name data. When accepting an operation for selecting a card to sell at the card selection screen for selling illustrated in FIG. 10B, the control device 11 identifies card name data of the card. Moreover, when the card can be sold at the shop, the control device 11 deletes a usage permission code from the card data corresponding to the card name data in order to set the corresponding card data existing in a usable data area of the card database to an unusable state. Thereby, the card data is stored in the unusable data area of the card database, and the card data becomes unusable for the player. In addition, when card data existing in the usable data area is set to an unusable state, the control device 11 selects card name data from the card database and reads out card sell income data corresponding to the card name data. The control device 11 then adds credit data corresponding to the read-out card sell income data to the credit data stored in the RAM 13.

In addition, enemy monsters existing in a castle include a jewel monster, and credit is increased when the jewel monster is beaten. The operation of the jewel monster is controlled by the control device 11 for executing a game execution program. When the central character S, which operates according to an instruction from the player, beats the jewel monster, the control device 11 executes a credit changing process for varying the credit data stored in the RAM 13 so as to be increased by an amount corresponding to a jewel gain amount, which is the number of tokens corresponding to the sort of the jewel monster (S8).

When the player performs various game operations such as giving an instruction on an operation of the central character S to move the central character S in a castle as described above and succeeds in occupying the castle, the castle selection screen illustrated in FIG. 7 is displayed again at the display 2 after a predetermined performance. Accordingly, the player can make an attempt at the same castle or another castle by selecting a castle to attempt next at the castle selection screen.

In order to finish the game play, the player pushes the save/exit button 5e illustrated in FIG. 1. When accepting the button operation, the control device 11 displays a game exit selection screen illustrated in FIG. 11 over the image displayed at the display 2 (S9). At the game exit selection screen, a “Yes” button and a “No” button are displayed below a comment of “Exit Game?”. In order not to exit the game, the player moves the cursor to the “No” button with the control lever 4 and pushes the operation button 5a. Thereby, the game exit selection screen disappears and the game is restarted from the last screen. On the other hand, in order to finish the game play, the player moves the cursor to the “Yes” button with the control lever 4 and pushes the operation button 5a. When accepting the button operation, the control device 11 writes credit data or save data and a player ID stored in the RAM 13 on the magnetic card 9 with the card writer 17 and ejects the magnetic card 9 through the card insert/eject slot 8 (S10).

In addition, the player can also convert credit data, which is a game medium in a state of electronic data stored in the RAM 13, to a token, which is a game medium in a tangible object state, and receive a paid-back token. In such a case, the player pushes the payout button 5d illustrated in FIG. 1. When accepting the button operation, the control device 11 controls the token ejection hopper 16 to perform a credit pay-back process for ejecting tokens, the number of which corresponds to the credit data stored in the RAM 13, from the token payback slot 7.

Next, the content of image display control, which is a characteristic part of the present invention, will be explained.

On the game screen illustrated in FIG. 8, the castle screen for illustrating a part of the castle, which is a virtual field constituted of a two-dimensional plane, is displayed. In addition, the number of floors of the castle, the vitality of the central character S and the credit amount indicating the amount of credit data of the player are displayed at the upper part of the castle screen, and a list of cards owned by the central character S (list of cards usable for the player during procession of the game) is displayed at the lower right part of the castle screen. The castle screen is obtained by viewing a field inside the castle from above, and the central character S is always displayed at the center of the castle screen.

The castle screen of the present embodiment has a displayed area of 9 divisions in horizontal direction times 7 divisions in vertical direction, although the area of the visible field is narrowed down to an area of 5 divisions in horizontal direction times 5 divisions in vertical direction in order to raise the difficulty level of the game. That is, a part of the castle screen where a semi-transparent mask image (shaded area in the figure) is superimposed indicates an adjacent field adjacent to the visible field from outside, and a castle screen part where the mask image is not superimposed indicates the visible field in FIG. 8. As described above, the present embodiment has a structure which makes it possible for the player to identify the visible field part and the adjacent field part in the castle screen, using the semi-transparent mask image.

The control device 11, which is a location decision unit for executing the game execution program to control procession of the game, functions as location decision means to decide the location of various objects such as background objects, which constitute floors or walls of the castle, the enemy monsters M1, M2, M3, or items such as the magic card. In addition, the control device 11 as the location decision unit functioning as location decision means changes the location of the enemy monsters M1, M2, M3 in series according to a location changing condition based on the content of the game execution program. Thereby, when, for example, the location of the enemy monsters is changed in the visible field, display control is carried out in a manner that the images of the enemy monsters are moved on the castle screen.

Here, in the game situation illustrated in FIG. 8, three enemy monsters including two enemy monsters M1, M2 positioned inside the visible field and one enemy monster M3 positioned in the adjacent field are located around the central character S as illustrated in FIG. 12. In addition, FIG. 12 illustrates the castle screen of a case where a transparentizing process, which will be described later, is not executed by the control device 11 in the game situation illustrated in FIG. 8, for the purpose of illustration.

In the present embodiment, the situation around the central character S, specifically what sorts of enemy monsters are positioned around the central character S, becomes important information for the player to decide an action of the next turn. Accordingly, the present embodiment is constructed in a manner that the player cannot see enemy monsters positioned outside the visible field, in order to raise the difficulty level of the game by superimposing the mask image on the castle screen and narrowing down the visible field. Concretely, the control device 11 as a display control unit functioning as display control means executes a transparentizing process for transparentizing an image of an enemy monster, which is the specific object, similar to the enemy monster M3 when the enemy monster is positioned in the adjacent field, so that the player cannot see the enemy monster. On the other hand, when the location of the enemy monster M3 is moved upward by one division and the image of the enemy monster M3 is moved from the adjacent field to the visible field, an opacifying process for opacifying the image is executed so that the player can see the enemy monster as illustrated in FIG. 13. In addition, an already known method can be widely used for such a transparentizing process and an opacifying process.

If the transparentizing process described above is not executed, a part of the image of the enemy monster M3 positioned in the adjacent field on the outside of the visible field comes into the visible field as illustrated in FIG. 12. Since the mask image is not superimposed on the part coming into the visible field, the player can easily see the part. This detracts the game attractiveness to raise the difficulty level of the game by superimposing the mask image to narrow down the visible field so as to prevent the player from understanding the sort or the position of the enemy monster positioned outside the visible field. Specifically in the present embodiment, the semi-transparent mask image is used for the image of background objects or the like, which are not the specific object such as enemy monsters or items positioned outside the visible field, so that the player can see the background objects or the like. The player can therefore easily understand the sort or the position of the enemy monster positioned outside the visible field. That is, when an opaque mask image is used, the player can see only a part, which comes into the visible field, of the entire image of the enemy monster and, therefore, a player who does not detect the part does not understand the position or the sort of the enemy monster, or even a player who detects the part sometimes has difficulty in understanding the sort of the enemy monster precisely. In contrast, when the semi-transparent mask image is used, an image part of the enemy monster, where the mask image is superimposed, can also be seen and, therefore, the player can see the entire image of the enemy monster. Therefore, it becomes much easier for the player to understand the sort or the position of the enemy monster positioned outside the visible field than in a case where the opaque mask image is used.

However, with the present embodiment for executing the transparentizing process described above, the image of the enemy monster M3 positioned in the adjacent field is transparentized so that the player cannot see the image. Accordingly, the player cannot understand the sort or the position of the enemy monster M3 positioned outside the visible field, although the player can understand the sort or the position of the enemy monsters M1, M2 positioned inside the visible field. As a result, it is possible to ensure the game attractiveness to be obtained by narrowing down the visible field in order to raise the difficulty level of the game as described above.

In addition, the opaque mask image may be used as illustrated in FIG. 17B, although the semi-transparent mask image is used as the mask image in the present embodiment. In such a case, when the transparentizing process described above is not executed, the player can also see the part, which comes into the visible field, of the image of the enemy monster M3 and understand the sort or the position of the corresponding enemy monster M3 based on the part. Accordingly, it is also required to execute the transparentizing process in order to ensure the game attractiveness described above, even when the opaque mask image is used.

Moreover, although the mask image is used to mark off the visible field in the present embodiment, it is the same with the case where the mask image is not used and the entire displayed area of the castle screen is used as the visible field as illustrated in FIG. 17C.

### MODIFIED EXAMPLE

Next, a modified example of the above embodiment will be explained.

The description of the present modified example will explain a case where the castle is constituted of a three-dimensional virtual space and various objects are three-dimensional objects, although the castle in the above embodiment is constituted of the two-dimensional virtual plane and various objects are two-dimensional objects. In addition, a basic structure of the present modified example is the same as that of the above embodiment and, therefore, the following description will mainly explain a part which is different from the structure of the above embodiment.

FIG. 14 is an explanatory view in which a part of the castle screen of the present modified example is enlarged. In addition, three divisions surrounded by double dotted chain lines in FIG. 14 are one division F1 where the central character S is positioned and two divisions F2, F3 positioned above the division F1 in the figure.

In the present modified example, the semi-transparent mask image illustrated as a shaded area in the figure is used to narrow down the area of the visible field to an area of 3 divisions in horizontal direction times 3 divisions in vertical direction around the central character S in order to raise the difficulty level of the game. Consequently, in FIG. 14, a part of the castle screen where the semi-transparent mask image (shaded area in the figure) is superimposed indicates the adjacent field adjacent to the visible field from outside, and a castle screen part where the mask image is not superimposed indicates the visible field.

The control device 11, which is the location decision unit for executing the game execution program and controlling procession of the game, functions as location decision means to decide the location of various objects such as background objects, which constitute floors or walls of the castle, enemy monsters M1, M2, M3 or items such as a magic card, as in the case of the above embodiment. In addition, the control device 11, which is the location decision unit functioning as location decision means, changes the location of the enemy monsters in series according to the location changing condition based on the content of the game execution program. Thereby, when, for example, the locations of enemy monsters are changed in the visible field, display control is carried out in a manner that the images of the enemy monsters are moved on the castle screen.

Here, in the present modified example, an enemy monster M4 is located at a division denoted by a mark F3 in FIG. 14. However, since the division F3 is the adjacent field on the outside of the visible field, the transparentizing process is executed for the image of the enemy monster M4 positioned at the division F3, as in the above embodiment. In addition, a method of setting the transparency of a mesh constituting the enemy monster M4 to 100%, a method of setting the transparency of a texture constituting the enemy monster M4 to 100%, a method of setting the transparency of a pixel constituting the enemy monster M4 to 100% or the like can be used as a method for transparentizing the image of the enemy monster M4, which is the three-dimensional object, although another heretofore known method may be adopted.

Next, a method of drawing the castle screen in the present modified example will be explained.

FIG. 15 is an explanatory view showing a schematic image of each object in a state where the central character S is viewed from a direction parallel to the floor, which is the right side in FIG. 14, in the game situation illustrated in FIG. 14.

In the present modified example, objects to be located in the castle (virtual field) can be classified roughly into floor objects; masking objects; background objects on the floor, which are to be laid on the floor such as walls or lights; and character objects such as the central character S, the enemy monster M4 and items. Moreover, since the images of these objects in a state where the inside of the castle is viewed from a viewpoint direction such as looking down the inside of the castle are displayed at the display 2 in the present modified example, the priority of image display of these objects normally becomes higher when the object is at a higher position in the castle. Consequently, in a normal order of priority, the order is the character objects or the background objects on the floor, the masking object, and then the floor object. However, when various objects are displayed in this order of priority, it becomes impossible to superimpose the image of the masking object (mask image) on the background objects on the floor which is positioned in the adjacent field on the outside of the visible field. Accordingly, in such a case, it becomes impossible to distinguish between the visible field and the adjacent field with the mask image, in terms of the background objects on the floor. Therefore, the present modified example adopts the following order of priority of display of object images: the masking object, the character objects or the background objects on the floor, and then the floor object. Thereby, it is also possible to distinguish between the visible field and the adjacent field with the mask image, even in terms of the background objects on the floor.

In addition, it is possible to distinguish between the visible field and the adjacent field with the mask image in terms of the background objects on the floor even when displayed in the normal order of priority of display, when the masking object is arranged at a position higher than other objects. However, the case of the castle (virtual field) constituted of the three-dimensional space as in the present modified example has an advantage that the player can be informed of the situation around the central character S through the display 2 from various directions by changing the viewpoint direction. Here, in the present modified example, the visible field is decided with reference to the floor. That is, on the floor, the inside of a predetermined area from the floor part where the central character S is positioned (9 divisions around a division where the central character S is positioned in the present modified example) is recognized as the visible field. Accordingly, when the masking object is at the same height as the floor as in the present modified example, the player can be informed of the area of the visible field on the floor precisely when the viewpoint direction is changed in terms of the same visible field, without moving the masking object. In contrast, when the masking object is arranged at a position (e. g., a ceiling position in the castle) higher than other objects as described above, a part on the floor where the mask image is superimposed is changed when the viewpoint direction is changed in terms of the same visible field and, therefore, the player cannot be informed of the area of the visible field on the floor precisely as long as the masking object is not moved in accordance with the change in the viewpoint direction. To perform such a heavily-loaded process of moving the masking object every time the viewpoint direction is changed causes deterioration in the process speed and an increase in cost, and is unfavorable.

Moreover, on the castle screen illustrated in FIG. 14, the enemy monster M4, for which the transparentizing process is executed as illustrated in FIG. 15, is located at a division F3 (adjacent field) two divisions above the central character S. When the location of the transparentized enemy monster M4 is changed to a division one division below the present division F3, i. e., a division F2 (visible field) one division above the central character S, the image of the enemy monster M4 becomes opaque by the opacifying process and is displayed at the display 2. Here, the image of the enemy monster M4 can be changed from a transparent image to an opaque image abruptly when a change in the location to the division F2 is completed. However, in such a case, the player feels as if the enemy monster M4 suddenly appears at the division F2, and performance effect becomes different from the original movement that the enemy monster M4 has moved from the division F3 to the division F2. In addition, when the image of the enemy monster M4 is changed from the transparent state to the opaque state abruptly, the player experiences an uncomfortable feeling and the atmosphere of the game forged with effort is destroyed.

Therefore, in the present modified example, when the location of the enemy monster M4 is to be changed from the division F3, which is the adjacent field, to the division F2, which is the visible field, the control device 11 as a display control unit functioning as display control means carries out display control to move the image of the enemy monster M4 positioned in the division F3 to the division F2 and also executes an opacifying process for gradually changing the image of the enemy monster M4 from the transparent state to the opaque state. Thereby, the display 2 can express thereon how the image of the enemy monster M4 moves from the division F3 to the division F2 as illustrated in FIG. 16A through FIG. 16C. Furthermore, since the image of the enemy monster M4 gradually appears on the display 2, it becomes possible to reduce the uncomfortable feeling of the player and to prevent the atmosphere of the game from being destroyed.

In addition, in the present modified example, when the location of an enemy monster is to be changed from the visible field to the outside of the visible field on the contrary, the control device 11, which is a display control unit functioning as display control means, carries out display control to move the image of the enemy monster positioned in the visible field to the outside of the visible field and also executes a transparentizing process for gradually changing the image of the corresponding enemy monster from the opaque state to the transparent state. In such a case, the display 2 can also express thereon how the image of the enemy monster is moved from the visible field to the outside of the visible field and, moreover, it becomes possible to reduce the uncomfortable feeling of the player and to prevent the atmosphere of the game from being destroyed.

In addition, the gradual change of the image of the enemy monster from the transparent state to the opaque state or the gradual change from the opaque state to the transparent state described above can offer a similar effect even when the castle (virtual field) is constituted of the two-dimensional virtual plane as in the above embodiment.

As described above, with the present embodiment (including the modified example), the images of the enemy monsters M3, M4 are transparent when the enemy monsters (specific objects) located in the castle, which is the virtual field, is positioned in the adjacent field on the outside of the visible field. Consequently, it is possible to reliably prevent the images of the enemy monsters positioned outside the visible field from being seen by the user without complicating a location decision process of the enemy monsters in the castle.

Moreover, since not only the visible field but also the adjacent field is displayed at the display 2 and the semi-transparent image is used as the mask image for visually differentiating these fields in the present embodiment (including the above modified example), the player can see objects (such as background objects) other than the specific object such as enemy monsters or items positioned in the adjacent field. Accordingly, a displayed area to be displayed at the display 2 can be expanded while preventing the specific object (such as enemy monsters), which is required not to be seen by the user when positioned outside the visible field in order to ensure the game concretely or the like, from being seen by the user.

Furthermore, by gradually changing the image of the specific object from the transparent state to the opaque state or gradually changing the image of the specific object from the opaque state to the transparent state when the location of the specific object such as the enemy monster is changed from one of the visible field and the adjacent field to the other, how the specific object moves can be expressed at the display 2 and, moreover, it becomes possible to reduce the uncomfortable feeling of the player and to prevent the atmosphere of the game from being destroyed.

In addition, the visible field in the present embodiment (including the above modified example) is marked off by a division unit, which is obtained by sectioning the virtual field into a squares shape and, therefore, the shape thereof is a rectangle. However, arbitrary area, which is a part of the virtual field, may be set as the visible field and the shape thereof may be a square, a circle, an ellipse or the like. In addition, the area of the visible field to be set may be the inside of a predetermined area around an image of an operational object such as the central character to be operated by the player, for example, or may be the inside of a predetermined area around a predetermined relative position to the image of the operational object.

In addition, although the description of the present embodiment (including the above modified example) has explained the present invention using the example of the token-operated game machine to be located at the amusement arcade, the present invention can be applied not only to the token-operated game machine but also to all game apparatus such as another arcade game apparatus such as a coin-operated video game machine, a home-use game apparatus, or a game apparatus which uses a network such as the Internet.

In addition, the present invention can be applied not only to a game apparatus but also to an apparatus required to display, at a display unit, an image of an object located in a visible field, which is a part of a virtual field constituted of a two-dimensional virtual plane or a three-dimensional virtual space, in a state where the visible field is viewed from a predetermined viewpoint direction and to prevent a specific object from being seen by the user when the specific object is positioned outside the visible field.

In addition, the present invention can be applied to various kinds of games, although the present embodiment (including the above modified example) has been explained using the role-playing game in which the player performs an operation to give such an instruction on the action of the central character S that the central character S goes off on the adventure in the dungeon or tries to occupy the castle. For example, the present invention can be applied to a shooter game in which the player performs an operation to give an instruction on an action of own fighter plane, which is an operational object, so that own fighter plane tries to occupy an enemy base while shooting down enemy fighter planes.

In addition, means realized by software such as computer programs in the present embodiment may be realized by hardware such as circuits or chips, and means realized by hardware such as circuits or chips in the present embodiment may be realized by software such as computer programs.

1. An image display control device comprising:
an image information storage unit for storing image information necessary for displaying, at a display unit, an image of various objects located in a virtual field constituted of a two-dimensional virtual plane or a three-dimensional virtual space;
a location decision unit for deciding location of various objects in the virtual field; and
a display control unit for executing display control to display, at the display unit, the image of the object located in a visible field, which is a part of the virtual field, in a state where the visible field is viewed from a predetermined viewpoint direction, based on location of the objects decided by the location decision unit and image information stored in the image information storage unit, a transparentizing process for transparentizing an image of a specific object located in the virtual field by the location decision unit when the specific object is positioned at least in an adjacent field adjacent to the visible field on the outside of the visible field, and an opacifying process for opacifying an image of the specific object when the specific object is positioned inside the visible field.

2. The image display control device according to claim 1,
wherein the virtual field is constituted of a three-dimensional virtual space,
at least the specific object among the various objects is a three-dimensional object, and
the display control unit changes a viewpoint direction according to a predetermined viewpoint direction changing condition.

3. The image display control device according to claim 1,
wherein the display control unit executes display control to display, at the display unit, the image of the object located in the visible field together with an image of another object excluding the specific object located in the adjacent field, and
a field differentiation processing unit for executing image processing for visually differentiating the visible field and the adjacent field is provided.

4. The image display control device according to claim 3,
wherein the image processing to be executed by the field differentiation processing unit is a process for generating an image obtained by superimposing a semi-transparent mask image on the image of the object located in the adjacent field.

5. The image display control device according to claim 1,
wherein the location decision unit changes location of the specific object according to a predetermined location changing condition, and
the display control unit executes display control to move the image of the specific object positioned in the adjacent field to the visible field and executes the opacifying process such that the image of the specific object gradually changes from a transparent state to an opaque state, when the location decision unit changes location of the specific object from the adjacent field to the visible field.

6. The image display control device according to claim 1,
wherein the location decision unit changes location of the specific object according to a predetermined location changing condition, and
the display control unit executes display control to move the image of the specific object positioned in the visible field to the outside of the visible field and executes the transparentizing process such that an image of the specific object gradually changes from an opaque state to a transparent state, when the location decision unit changes location of the specific object from the visible field to the outside of the visible field.

7. A game machine comprising:
a game screen display unit for displaying a game screen;
an operation acceptance unit for accepting an operation by a player;
a game control unit for causing a computer to execute a predetermined game execution program so as to control procession of a game according to content of a game operation accepted by the operation acceptance unit; and
an image display control unit for executing display control to display, at the game screen display unit, a game screen corresponding to procession of the game controlled by the game control unit,
wherein the image display control device according to claim 1 is used as the image display control unit, and
the location decision unit of the image display control device decides location of various objects in the virtual field according to control content of procession of the game by the game control unit.

8. A game machine comprising:
a game screen display unit for displaying a game screen;
an operation acceptance unit for accepting an operation by a player;
a game control unit for causing a computer to execute a predetermined game execution program so as to control procession of a game according to content of a game operation accepted by the operation acceptance unit; and
an image display control unit for executing display control to display, at the game screen display unit, a game screen corresponding to procession of the game controlled by the game control unit,
wherein the image display control device according to claim 2 is used as the image display control unit, and
the location decision unit of the image display control device decides location of various objects in the virtual field according to control content of procession of the game by the game control unit.

9. A game machine comprising:
a game screen display unit for displaying a game screen;
an operation acceptance unit for accepting an operation by a player;
a game control unit for causing a computer to execute a predetermined game execution program so as to control procession of a game according to content of a game operation accepted by the operation acceptance unit; and
an image display control unit for executing display control to display, at the game screen display unit, a game screen corresponding to procession of the game controlled by the game control unit,
wherein the image display control device according to claim 3 is used as the image display control unit, and
the location decision unit of the image display control device decides location of various objects in the virtual field according to control content of procession of the game by the game control unit.

10. A game machine comprising:
a game screen display unit for displaying a game screen;
an operation acceptance unit for accepting an operation by a player;
a game control unit for causing a computer to execute a predetermined game execution program so as to control procession of a game according to content of a game operation accepted by the operation acceptance unit; and
an image display control unit for executing display control to display, at the game screen display unit, a game screen corresponding to procession of the game controlled by the game control unit,
wherein the image display control device according to claim 4 is used as the image display control unit, and
the location decision unit of the image display control device decides location of various objects in the virtual field according to control content of procession of the game by the game control unit.

11. A game machine comprising:
a game screen display unit for displaying a game screen;
an operation acceptance unit for accepting an operation by a player;
a game control unit for causing a computer to execute a predetermined game execution program so as to control procession of a game according to content of a game operation accepted by the operation acceptance unit; and
an image display control unit for executing display control to display, at the game screen display unit, a game screen corresponding to procession of the game controlled by the game control unit,
wherein the image display control device according to claim 5 is used as the image display control unit, and
the location decision unit of the image display control device decides location of various objects in the virtual field according to control content of procession of the game by the game control unit.

12. A game machine comprising:
a game screen display unit for displaying a game screen;
an operation acceptance unit for accepting an operation by a player;
a game control unit for causing a computer to execute a predetermined game execution program so as to control procession of a game according to content of a game operation accepted by the operation acceptance unit; and
an image display control unit for executing display control to display, at the game screen display unit, a game screen corresponding to procession of the game controlled by the game control unit,
wherein the image display control device according to claim 6 is used as the image display control unit, and
the location decision unit of the image display control device decides location of various objects in the virtual field according to control content of procession of the game by the game control unit.

13. A program for causing a computer of an image display control device, which comprises an image information storage unit for storing image information necessary for displaying, at a display unit, an image of various objects located in a virtual field constituted of a two-dimensional virtual plane or a three-dimensional virtual space, to operate, wherein the program causes the computer to function as:
a location decision unit for deciding location of various objects in the virtual field; and
a display control unit for executing display control to display, at the display unit, an image of the object located in a visible field, which is a part of the virtual field, in a state where the visible field is viewed from a predetermined viewpoint direction, based on location of the objects decided by the location decision unit and image information stored in the image information storage unit, a transparentizing process for transparentizing an image of a specific object located in the virtual field by the location decision unit when the specific object is positioned at least in an adjacent field adjacent to the visible field on the outside of the visible field, and an opacifying process for opacifying an image of the specific object when the specific object is positioned in the visible field.

14. A recording medium having a program for causing a computer of an image display control device, which comprises an image information storage unit for storing image information necessary for displaying, at a display means unit, an image of various objects located in a virtual field constituted of a two-dimensional virtual plane or a three-dimensional virtual space, to operate, wherein the program causes the computer to function as:
a location decision unit for deciding location of various objects in the virtual field; and
a display control unit for executing display control to display, at the display unit, an image of the object located in a visible field, which is a part of the virtual field, in a state where the visible field is viewed from a predetermined viewpoint direction, based on location of the objects decided by the location decision unit and image information stored in the image information storage unit, a transparentizing process for transparentizing an image of a specific object located in the virtual field by the location decision unit when the specific object is positioned at least in an adjacent field adjacent to the visible field on the outside of the visible field, and an opacifying process for opacifying an image of the specific object when the specific object is positioned in the visible field.
